(19) United States
(12) Patent Application Publication
(10) Pub. No.: US 2021/0045370 A1
(43) Pub. Date: Feb. 18, 2021

(54) FISHING LURE ASSEMBLIES AND RELATED METHODS

(71) Applicant: Kenneth Scott CANTRELL, McDonough, GA (US)

(72) Inventor: Kenneth Scott CANTRELL, McDonough, GA (US)

(21) Appl. No.: 16/991,179

(22) Filed: Aug. 12, 2020

Related U.S. Application Data
(60) Provisional application No. 62/885,628, filed on Aug. 12, 2019.

(51) Int. Cl. A01K 85/00

(52) U.S. Cl. CPC A01K 85/00

(57) ABSTRACT

Fishing lure assemblies and related methods are provided. A representative fishing lure assembly incorporates: a primary prey member configured as fish prey of a first type; and a secondary prey member, configured as fish prey of a second type, attached to the primary prey member; wherein the first type and the second type are different types of fish prey. A representative method for catching fish includes: providing a fishing lure assembly having a primary prey member and a secondary prey member; disposing a barbed end of a first fishing hook at least partially through the primary prey member; attaching a fishing line to the first fishing hook; and casting the fishing lure assembly into a body of water.

### CROSS-REFERENCE TO RELATED APPLICATIONS

This utility patent application claims the benefit of and priority to U.S. Provisional Patent Application 62/885,628, filed on 12 Aug. 2019, which is incorporated by reference herein in its entirety.

### BACKGROUND

### Technical Field

The disclosure relates to the field of fishing and, more specifically, to fishing lures for catching fish.

### DESCRIPTION OF THE RELATED ART

The art of fishing has been around for thousands of years. In the ancient past, individuals fished to feed themselves and their families. Artificial fishing lures started being used as early as ancient Roman and Greek times. Today, fishing is a multibillion-dollar sport. Notably, there are professionally sanctioned fishing tournaments in which competitors must use artificial lures exclusively. Many different types of lures have been developed to resemble and imitate some form of natural prey that a predatory fish typically or atypically feeds upon.

One problem with conventional artificial lures is that they rely heavily upon specific techniques controlled by the angler, such as sudden pauses in retrieval, erratic twitching of the rod tip, or bumping the lure into rocks or other structures in order to make the lure appear as if it were a wounded target. Otherwise, these lures would blend in with the hundreds or even thousands of naturally occurring prey items that are already within the area being fished.

Another limitation with conventional artificial lures is keeping the lure in the desired location for an extended period of time in order to entice a fish to strike. Current lures such as swim baits, crank baits, spinner baits, buzz baits, top water plugs, and soft plastic lures are representations of prey items swimming through the water or crawling along the bottom. In order for these lures to achieve the desired action, a slow or steady retrieve often is performed, which brings the lure back to the angler and requires additional casts to the desired area.

Therefore, what is needed are fishing lure assemblies and related methods for addressing one or more of these perceived shortcomings.

### SUMMARY

Fishing lure assemblies and related methods are provided. In an example embodiment, a fishing lure assembly comprises: a primary prey member configured as fish prey of a first type; and a secondary prey member, configured as fish prey of a second type, attached to the primary prey member; wherein the first type and the second type are different types of fish prey.

In some embodiments, the primary prey member is formed of an elastomeric plastic. In some embodiments, the fishing lure assembly further comprises a first fishing hook having a barbed end; and the primary prey member is configured to receive, at least partially therethrough, the barbed end of the first fishing hook.

In some embodiments, the secondary prey member is formed of an elastomeric plastic.

In some embodiments, the fishing lure assembly further comprises a second fishing hook having a barbed end; and the secondary prey member is configured to receive, at least partially therethrough, the barbed end of the second fishing hook.

In some embodiments, the primary prey member is configured as a crawfish having a first appendage; and the secondary prey member is attached to the first appendage.

In some embodiments, the secondary prey member is configured as a shad.

In some embodiments, the first appendage has a holding claw disposed at a distal end thereof, the holding claw defining a holding chamber; and at least a portion of the secondary prey member is received within the holding chamber.

In some embodiments, the secondary prey member has a first end, a second end, and an intermediate portion disposed between the first end and the second end; and the intermediate portion of the secondary prey member is received within the holding chamber such that the first end and the second end are disposed outside of the holding chamber.

In some embodiments, the secondary prey member has a groove formed about an exterior thereof; and the holding chamber is configured to engage the groove to attach the secondary prey member to the primary prey member.

An example embodiment of a method for catching fish comprises: providing a fishing lure assembly having a primary prey member and a secondary prey member, the primary prey member being configured as fish prey of a first type, the secondary prey member being configured as fish prey of a second type and attached to the primary prey member, the first type and the second type being different types of fish prey; disposing a barbed end of a first fishing hook at least partially through the primary prey member; attaching a fishing line to the first fishing hook; and casting the fishing lure assembly into a body of water.

In some embodiments, casting the fishing lure assembly comprises releasing a length of the fishing line to enable the fishing lure assembly to rest on a bottom of the body of water.

In some embodiments, the method further comprises disposing a barbed end of a second fishing hook at least partially through the secondary prey member.

### BRIEF DESCRIPTION OF THE SEVERAL VIEWS OF THE DRAWINGS

A more complete understanding of the disclosure may be had by reference to the following Detailed Description when taken in conjunction with the accompanying drawings, in which like reference numerals indicate corresponding parts throughout the several views.

FIG. 1 is a top view of an example embodiment of a primary prey member (crawfish member).

FIG. 2 is a left side view of the crawfish member in FIG. 1.

FIG. 3 is a right side view of an example embodiment of a secondary prey member (shad member).

FIG. 4 is a top view of the shad member in FIG. 3.

FIG. 5 is a top view of the crawfish member in FIGS. 1 and 2 and the shad member in FIGS. 3 and 4 attached to form an example embodiment of a fishing lure assembly.

FIG. 6 is a top view of another example embodiment of a primary prey member (crawfish member).

FIG. 7 is a left side view of another example embodiment of a secondary prey member (shad member).

FIG. 8 is a top view of the crawfish member in FIG. 6 and the shad member in FIG. 7 attached to form another example embodiment of a fishing lure assembly.

FIG. 9 is a left side view of the embodiment of the fishing lure assembly in FIG. 8 with a primary and secondary hook attached.

FIG. 10 is a top view of another embodiment of a primary prey member (crawfish member).

FIG. 11 is a top view of another embodiment of a secondary prey member (worm member).

FIG. 12 is a top view of the crawfish member in FIG. 10 and the worm member in FIG. 11 attached to form another embodiment of a fishing lure assembly.

FIG. 13 is a left side view of another embodiment of a fishing lure assembly.

FIG. 14 is a schematic view of a fishing lure assembly in use for fishing predatory fish.

### DETAILED DESCRIPTION

Conventional artificial fishing lures are not configured to appear as prey that are distracted or preoccupied with a meal. Studies have shown that predatory fish are more likely to advance on a prey item if there is a higher chance of success. This is because a chase for food that is unsuccessful for the predator wastes valuable energy. Presenting a fishing lure assembly configured as prey that appears distracted with a meal of another prey item is believed to result in a higher number of strikes from predatory fish owing to these instinctual behaviors.

In this regard, example embodiments of a fishing lure assembly and related methods are provided that involve the use of fishing lure configurations that represent distracted or preoccupied prey. In use, such a fishing lure assembly may be left in a desired location for an extended period of time without detracting from its efficacy.

In some embodiments, a fishing lure apparatus incorporates a primary prey member and a secondary prey member that are attached to each other, with each being configured as a different type of prey. By way of example, the primary prey member may take on various forms, such as a crawfish or fish (e.g., a shad), among numerous others, and the secondary prey member may take on various forms, such as a fish or worm, among various others.

In an example crawfish-configured embodiment, the primary prey (or crawfish) member may include a holding claw in which a holding chamber is located to securely attach a secondary prey member, which may be configured as a shad, for example. So configured, the crawfish member appears to be grasping and feeding on the shad member when the two are attached. The fishing lure assembly may use one or more of various fishing hooks designed to be fished with soft plastic lures that are tied to a main fishing line. This offering appeals to predatory fish on site. The crawfish appears to be distracted, and the chance of success is perceived by the predatory fish to be increased by twofold. Specifically, the predatory fish perceives an opportunity to capture the two prey items together or either of the two prey items could be suitable for capture if they become unattached during a strike. This is the perfect chance for the fish to obtain an easy meal. Furthermore, the crawfish would be perceived as competition for food to a predatory fish, potentially further provoking a strike.

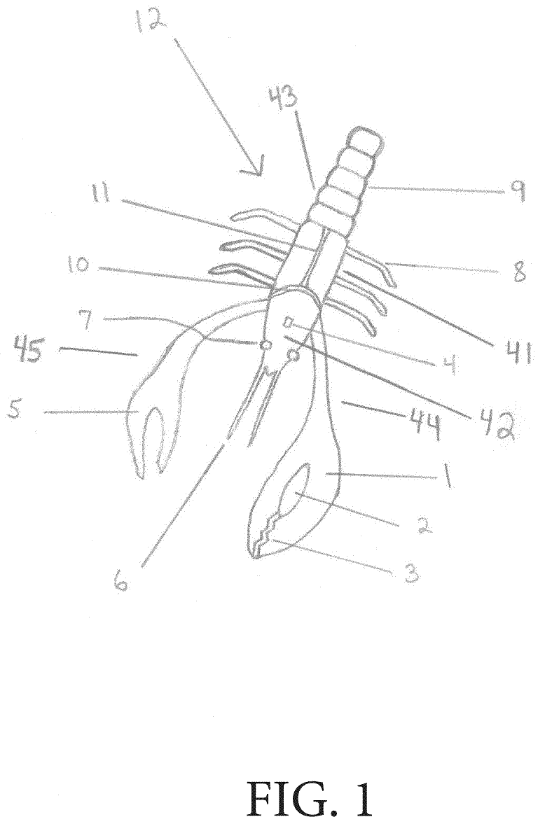

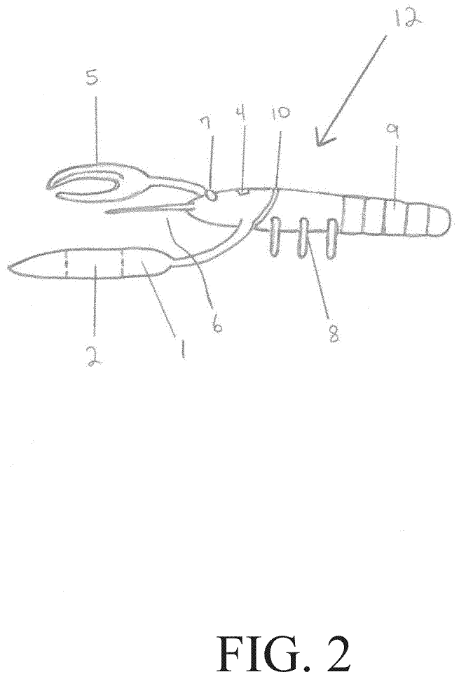

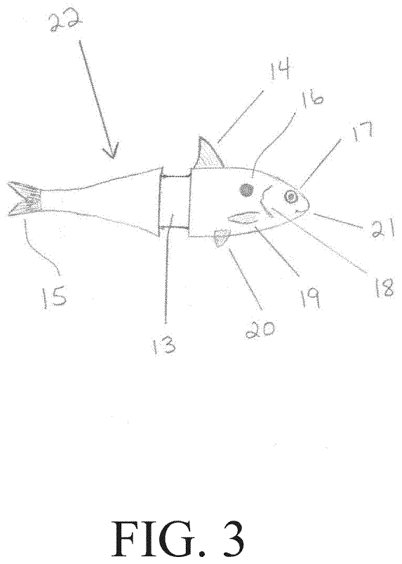

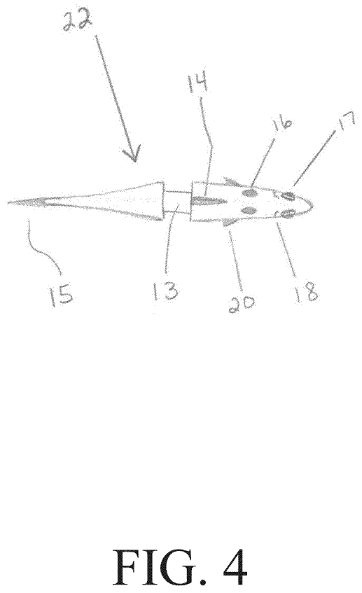

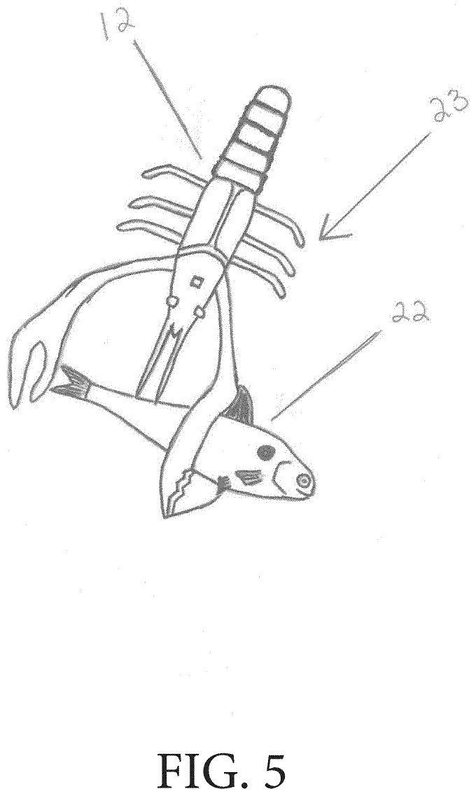

Referring now to the drawings, an example embodiment of a fishing lure assembly (23) is illustrated in FIGS. 1 through 5. The fishing lure assembly (23) includes a primary prey member (e.g., a crawfish member) (12) and a secondary prey member (e.g., a shad member) (22). That is, the primary prey member is configured as fish prey of a first type, and the secondary prey member is configured as fish prey of a second type that is different (e.g., a different class, order, family, genus or species) than the first type of fish prey. In some embodiments, the first type and second type of prey are of different animal classes.

The two members (12) and (22) are preferably formed or molded of, but not limited to, a suitable elastomeric material selected from the thermoplastic polymer family, such as, for example, polyvinyl chloride (PVC), or what is commonly known as “plastisol”. So formed, at least one of the members is configured to receive, at least partially therethrough, a portion of a corresponding fishing hook.

The crawfish member (12) incorporates a main body (41) disposed between a head portion (42) and a tail portion (43). Extending from main body (41) are appendages (44, 45) as well as scuttling legs (8). In this embodiment, each of the appendages extends forwardly and outwardly from the main body (41) to terminate beyond head portion (42). The scuttling legs (8) are arranged in two opposing sets of legs, with the legs of the first set extending laterally outwardly from main body (41) in a first direction and the second set of legs extending laterally outwardly from main body (41) in a second (opposite) direction. Distal or free ends of the scuttle legs (8) are also downwardly inclined to terminate below a lowest level of the main body (41) to facilitate contact with a surface upon which the fishing lure assembly is laid.

At the end of at least one of the appendages depends a holding claw (1), which defines a holding chamber (2). In this embodiment, the holding chamber is configured as a completely enclosed through-hole, whereas in other embodiments, various other configurations, such as slot configurations may be used. Holding chamber (2) is configured to removably secure the shad member (22) to holding claw (1) via a locking groove (13) disposed at an intermediate portion of the shad member (22), which corresponds to the size of the holding chamber (2). The sizes of the holding chamber (2) and locking groove (13) may vary depending on the desired size of the final lure embodiment. To facilitate attachment of shad member (22) to holding claw (1), tail fin (15) is threaded through the top side of the holding chamber (2) until the rigging stop fin (14) makes contact with the outer edge of the holding chamber (2). This permits the outer edges of the holding chamber (2) to align within the outer groove walls of the locking groove (13).

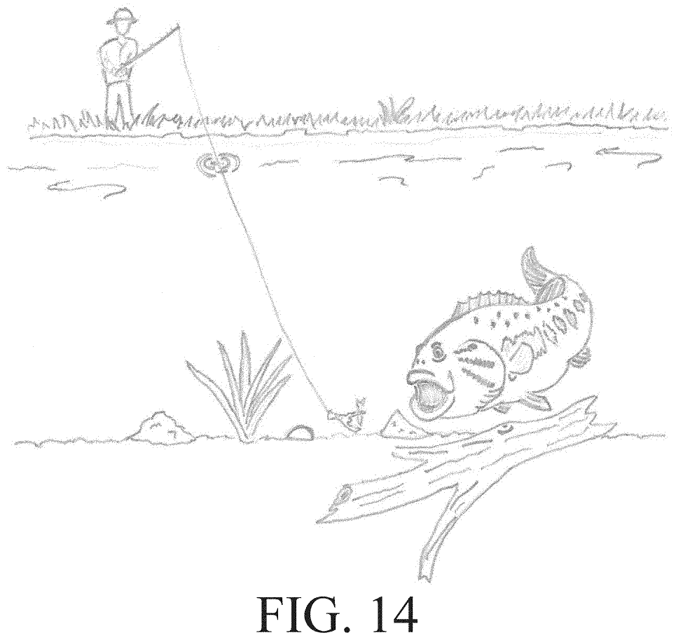

In use (such as depicted in FIG. 14), the fishing lure assembly may be attached to one of a variety of appropriate fishing hooks commonly used for fishing soft plastic lures. Preferably, the fishing hook is tied to a main fishing line, which is attached to a fishing reel mounted on a fishing rod. The crawfish member (12) is threaded onto the fishing hook so that the crawfish member (12) remains as straight as possible. This may be accomplished by inserting the point (or barbed end) of the hook through the center of the tip of the ribbed tail section (9) and having the tip of the hook exit through the desired location along the body shell seam (11) or the double trouble mark (4). The double trouble mark (4) is the desired main hook point exit if a 2/0 trailer hook or stinger hook is to be used in addition to the main hook. The ribbed tail section (9) may be cut to the desired length by a user to accommodate main hooks of various lengths.

Fishing lure assembly (23) with the associated hook(s) is cast to a desired location within a fishery and allowed to sink to the bottom. Simulating a crawfish feeding is best accomplished by shaking the rod tip gently to impart action to the lure while it remains in the desired location. If a user wishes to simulate a crawfish crawling along the bottom while holding its meal, then a slow retrieve can be used. This can be accomplished by slowly moving the fishing rod tip from left to right or vice versa and then reeling up line slack upon return of the initial rod tip position or by slowly turning the fishing reel handle to drag the lure in. The tips of the scuttling legs (8) extend down past the lowest portion of the main body of the crawfish member (12) to contact the substrate. When the lure is allowed to maintain contact with the bottom during a slow retrieve, the resilient scuttling legs (8) will catch the substrate and snap back to their original molded positions. This allows back and forth movement to the scuttling legs (8).

The outermost edge of the action claw (5) preferably is slightly thicker than its opening and inner most edge to provide a gradual inward taper, thereby providing action when the lure is pulled through the water. Additionally, optional aesthetic details may be incorporated into the crawfish member (12) and the shad member (22). The pincer groove (3) is located on both the top and bottom of the holding claw (1) and extends from the leading edge of the holding chamber (2) to the top of the holding claw. A pair of whiskers (6) and a set of goggle eyes (7) are for added realism, as well as a head shell seam (10) and body shell seam (11). The body shell seam (11) runs from the center of the head shell seam (10) and terminates at the start of the ribbed tail section (9) and is centered within the main body for hook alignment. The shad member's appearance may optionally benefit from the addition of eyes (17) that may be but are not limited to inserts or features of the shad mold, a mouth (21), gill covers (18), pectoral fins (19), and pelvic fins (20).

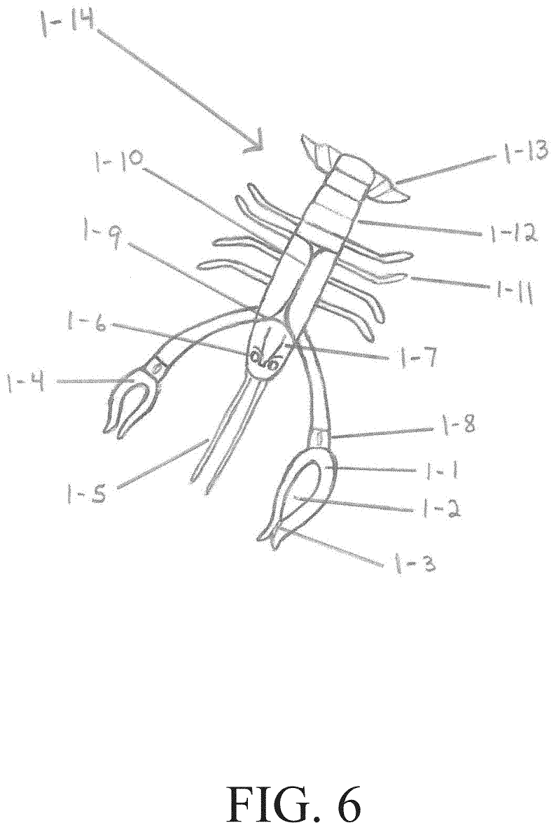

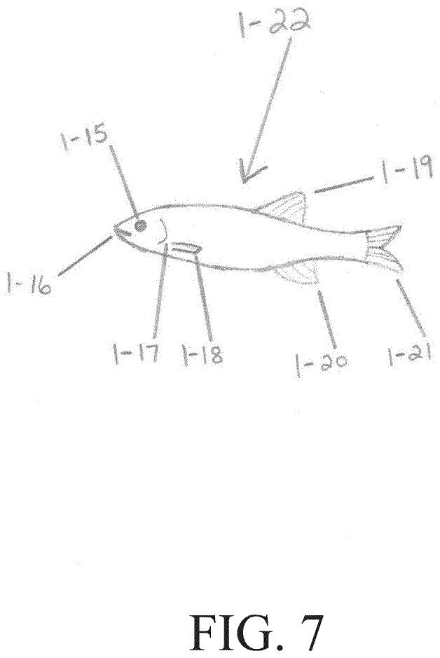

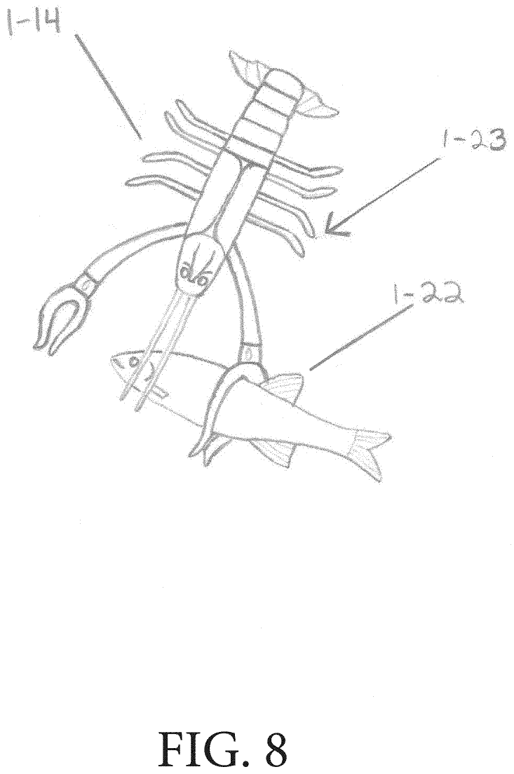

Another example embodiment of a fishing lure assembly (1-23) is illustrated in FIGS. 6 through 8. The fishing lure assembly (1-23) includes a primary prey member (e.g., a crawfish member) (1-14) and a secondary prey member (e.g., a shad member) (1-22). At the end of at least one of the appendages depends a holding claw (1-1), which defines a holding chamber (1-2). In this embodiment, the holding chamber is configured as a completely enclosed through-hole. Holding chamber (1-2) is configured to removably secure the shad member (1-22) to holding claw (1-1) via an adhesive (e.g., PVC glue). To facilitate attachment of shad member (1-22) to holding claw (1-1), tail fin (1-21) is threaded through the bottom side of the holding chamber (1-2) until the center portion of the shad member is located within the holding chamber (1-2). PVC glue is then applied with a suitable applicator or brush to both contacting surfaces of holding chamber (1-2) and shad member (1-22).

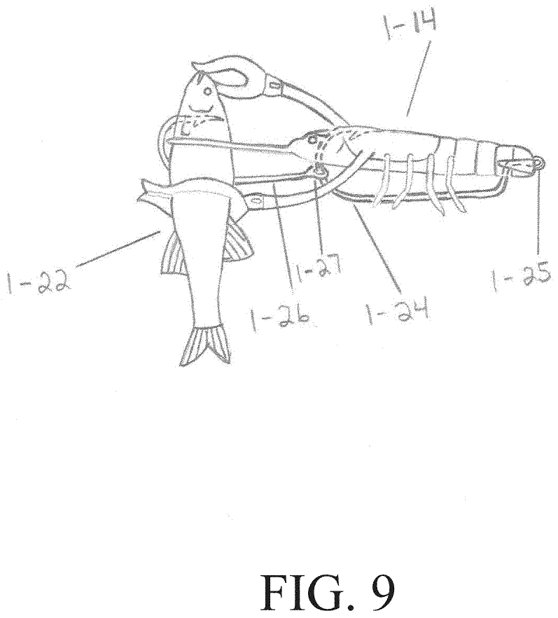

FIG. 9 illustrates placement of a primary hook (4/0 Offset Round Bend Hook) (1-24) and a secondary hook (2/0 Trailer Hook) (1-26) within the crawfish member (1-14) and the shad member (1-22).

It should be noted that crawfish are a common prey item for most freshwater predatory fish. Largemouth Bass and Black Bass, in particular, are known to forage on crawfish throughout all four seasons. Even though crawfish are a staple to the Largemouth Bass' diet, they are very careful while trying to ingest these clawed crustaceans. It has been observed through underwater filming that bass will oftentimes disarm a crawfish by biting off one or both claws before trying to ingest them.

There are many different techniques or rigging methods for fishing soft plastic crawfish lures. All of these methods, including Texas rigging, Carolina rigging, Tokyo rigging, Neko rigging, Ned rigging, and jig fishing utilize a single hook within the body of the artificial crawfish. This frequently leads to a predatory fish biting just short of the hook while targeting the claws of such lures. The result is a missed “hook up” with the fish and a crawfish lure missing one or both claws.

Embodiments of the fishing lure assembly preferably may be rigged with a primary hook and a secondary hook (“trailer hook”). In such a configuration, the crawfish member accommodates the primary hook, and the shad member accommodates the secondary hook that is secured to the primary hook. Rigging in this fashion will place the secondary hook closer to the fish's mouth during a strike, thus increasing the likelihood of hooking the fish.

In some configurations, it is preferable that a 4/0 offset shank round bend hook be used as the primary hook and a 2/0 trailer hook for the secondary hook. The combination of these two hook sizes allows for proper hook positioning within the fishing lure assembly. First, take the end of the fishing line that is attached to a fishing rod and reel and thread or tie on the desired fishing weight. Leave a tag end of approximately six inches if the weight was tied on. Some specialty weights accommodate direct hook placement with a clasp or snap secured to the weight. Next, take the loose end or tag end of the fishing line and securely tie it to the eye of the primary hook or secure the primary hook to the specialty weight. Once the hook is secured to the line or specialty weight, insert the tip or point of the primary hook into the center of the end of the crawfish tail and exit approximately ¼″ away from the end of the tail and out the bottom of the tail. Next, rotate the tip of the hook 180 degrees so that it is facing the bottom of the lure and then pull the shank of the hook until the eye enters the end of the tail completely. Now take the eye of the secondary hook and place it over the tip of the primary hook so that it is hanging off of the primary hook. Take the tip of the primary hook and enter the bottom of the crawfish's head and exit the top of the head so that the crawfish lies straight on the primary hook, and then texpose the tip of the primary hook back into the crawfish lure (i.e., skin hooking the tip of the hook back into the bait after it comes out of the bait) so that it will not snag on debris. At this point, the crawfish is rigged as in the “Texas Rig” manner with the exception of the trailer hook hanging from the primary hook. To finish rigging the fishing lure assembly, insert the tip of the secondary hook or trailer hook into the belly of the shad between the shad's head and the holding claw of the crawfish. Do not allow the tip of the secondary hook to exit out the back of the shad in order for the fishing lure assembly to remain weedless. Once a fish bites the lure and the rod is snatched back to set the hook, the secondary hook will penetrate through the shad and the mouth of the fish.

As mentioned above, predatory fish are very careful when trying to ingest crawfish. All predators, not just predatory fish, evaluate prey before committing to an attack. They instinctively evaluate the risk-to-reward ratio. Prey items that are assessed to be a lower risk are targeted before prey that could potentially harm the predator. For this reason, embodiments of the fishing lure assembly preferably incorporate one or more features to make it appear less menacing. First and foremost, the crawfish appears to be distracted or preoccupied with a meal. A distracted prey item poses less risk to a predator. Also, not all crawfish have claws of equal size, and some may have only one claw or none at all. Crawfish lose appendages frequently, but these appendages grow back. In some embodiments, a crawfish member may include a free claw (“active claw”) that is approximately two thirds the size of the holding claw. This is also a factor in presenting this artificial crawfish as a less menacing prey item.

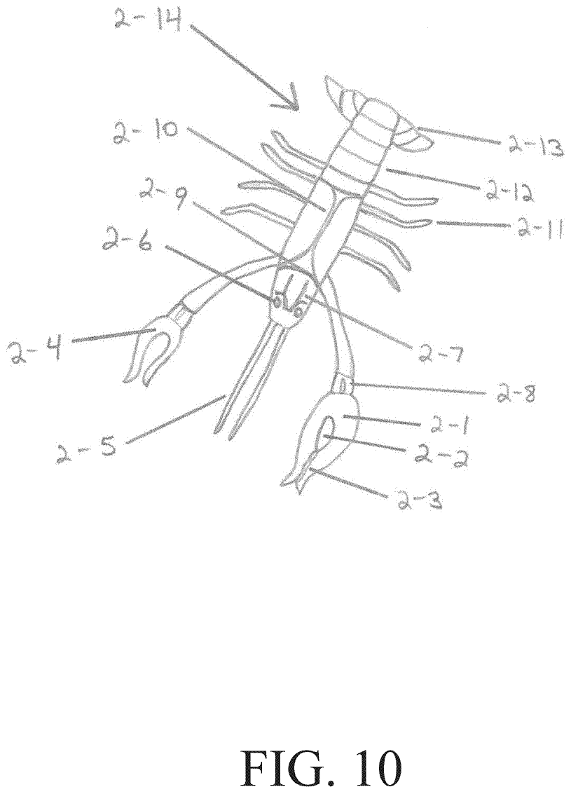

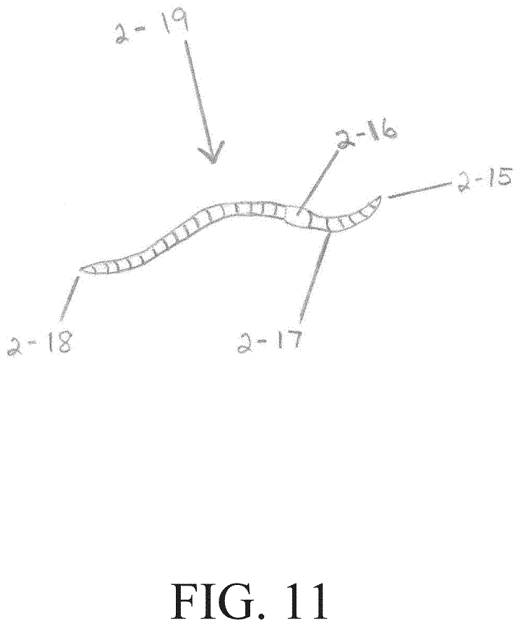

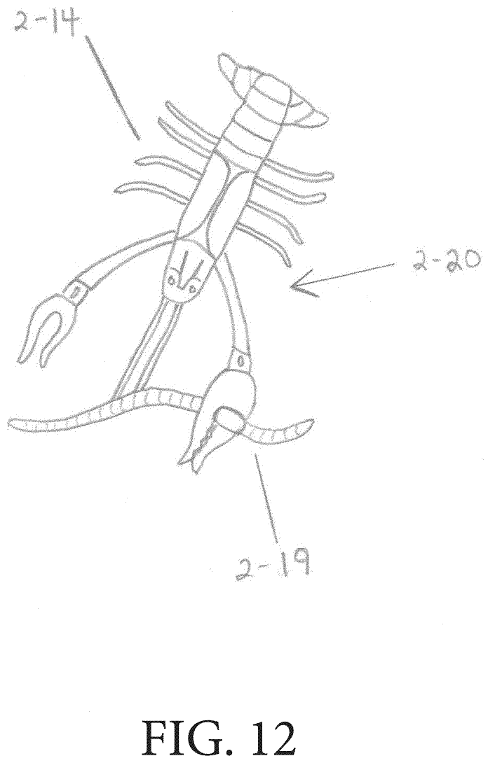

Another example embodiment of a fishing lure assembly (2-20) is illustrated in FIGS. 10 through 12. The fishing lure assembly (2-20) includes a primary prey member (e.g., a crawfish member) (2-14) and a secondary prey member (e.g., a worm member) (2-19). At the end of at least one of the appendages depends a holding claw (2-1), which defines a holding chamber (2-2). In this embodiment, the holding chamber is configured as a completely enclosed through-hole. Holding chamber (2-2) is configured to removably secure the worm member (2-19) to holding claw (2-1) via adhesive (e.g., PVC glue). To facilitate attachment of worm member (2-19) to holding claw (2-1), worm tail (2-18) is threaded through the top side of the holding chamber (2-2) until the clitellum (2-16) makes contact with top portion of holding claw (2-1). PVC glue is then applied with a suitable applicator or brush to both contacting surfaces of holding chamber (2-2) and worm member (2-19).

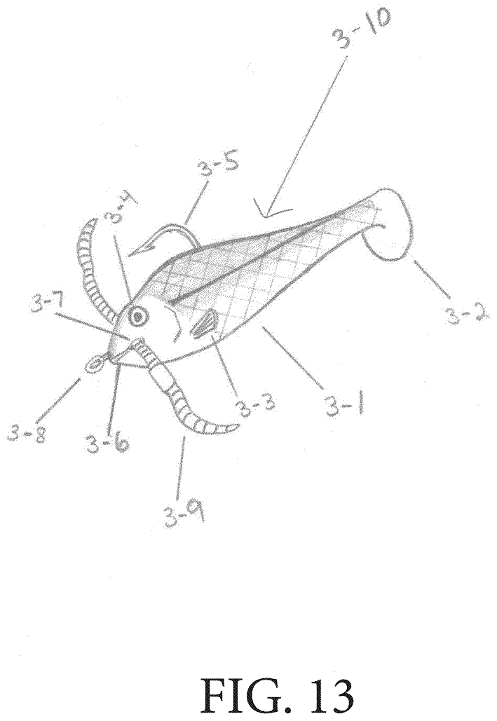

Yet another example embodiment of a fishing lure assembly (3-10) is illustrated in FIG. 13. The fishing lure assembly (3-10) includes a primary prey member (e.g., a baby bass member) (3-1) and a secondary prey member (e.g., a worm member) (3-9). The back of the mouth groove (3-6) defines a holding chamber (3-7). In this embodiment, the holding chamber is configured as a completely enclosed through-hole. Holding chamber (3-7) is configured to removably secure the worm member (3-9) via adhesive (e.g., PVC glue). To facilitate attachment of worm member (3-9) to holding chamber (3-7), worm tail is threaded through the left side of the holding chamber (3-7) as relative to baby bass (3-1) until equal lengths of worm member (3-9) extend from both sides of holding chamber (3-7). PVC glue is then applied with a suitable applicator or brush to both the inner contacting surface of holding chamber (3-7) and the outer contacting surface of worm member (3-9).

FIG. 14 illustrates an embodiment of a fishing lure assembly in use for fishing for predatory fish.

Although preferred embodiments have been illustrated in the accompanying Drawings and described in the foregoing Detailed Description, it should be understood the disclosure is not limited to the embodiments disclosed but is capable of rearrangement, modification, and substitution of parts and elements without departing from the spirit of the invention.

### COMPONENT LIST/ILLUSTRATION KEY

FIGS. 1-5
1. Holding Claw
2. Holding Chamber
3. Pincer Groove
4. Double Trouble Mark
5. Action Claw
6. Whiskers
7. Goggle Eyes
8. Scuttling Legs
9. Ribbed Tail Section
10. Head Shell Seam
11. Body Shell Seam
12. Crawfish Assembly
13. Holding Chamber Locking Groove
14. Rigging Stop Fin
15. Tail Fin
16. Shad Spot
17. Shad Eye
18. Shad Gill Cover
19. Shad Pectoral Fin
20. Shad Pelvic Fin
21. Shad Mouth
22. Shad Assembly
23. Fishing Lure Assembly
41. Main Body
42. Head Portion
43. Tail Portion
44. Left Appendage
45. Right Appendage

FIGS. 6-9
1-1. Holding Claw
1-2. Holding Chamber
1-3. Pincer Groove (1 mm groove top and bottom)
1-4. Action Claw
1-5. Whiskers (pair)
1-6. Goggle Eye (pair)
1-7. Head Crown
1-8. Wrists
1-9. Head Shell Seam
1-10. Body Shell Seam
1-11. Scuttling Legs
1-12. Ribbed Tail Section
1-13. Tail Edge (pair)
1-14. Crawfish Assembly
1-15. Shad Eye
1-16. Shad Mouth
1-17. Shad Gill Cover
1-18. Shad Pectoral Fin
1-19. Shad Dorsal Fin
1-20. Shad Anal Fin
1-21. Shad Tail Fin
1-22. Shad Assembly
1-23. Fishing Lure Assembly (Embodiment #2)
1-24. 4/0 Offset Round Bend Hook
1-25. 4/0 Offset Round Bend Hook Eye
1-26. 2/0 Trailer Hook
1-27. 2/0 Trailer Hook Eye

FIGS. 10-12
2-1. Holding Claw
2-2. Holding Chamber
2-3. Pincer Groove
2-4. Action Claw
2-5. Whiskers (Pair)
2-6. Goggle Eyes (Pair)
2-7. Head Crown
2-8. Wrists
2-9. Head Shell Seam
2-10. Body Shell Seam
2-11. Scuttling Legs
2-12. Ribbed Tail Section
2-13. Tail Fin Edge (Pair)
2-14. Crawfish Member
2-15. Worm Head
2-16. Clitellum
2-17. Ribs
2-18. Worm Tail
2-19. Worm Member
2-10. Fishing Lure Assembly

FIG. 13
3-1. Baby Bass Member
3-2. Paddle Tail
3-3. Pectoral Fin
3-4. Baby Bass Eye
3-5. Fishing Hook
3-6. Mouth Groove
3-7. Holding Chamber
3-8. Fishing Hook Eye
3-9. Worm Member
3-10. Fishing Lure Assembly

I claim:

1. A fishing lure assembly comprising:
a primary prey member configured as fish prey of a first type; and
a secondary prey member, configured as fish prey of a second type, attached to the primary prey member;
wherein the first type and the second type are different types of fish prey.

2. The fishing lure assembly of claim 1, wherein the primary prey member is formed of an elastomeric plastic.

3. The fishing lure assembly of claim 2, wherein:
the fishing lure assembly further comprises a first fishing hook having a barbed end; and
the primary prey member is configured to receive, at least partially therethrough, the barbed end of the first fishing hook.

4. The fishing lure assembly of claim 3, wherein the secondary prey member is formed of an elastomeric plastic.

5. The fishing lure assembly of claim 4, wherein:
the fishing lure assembly further comprises a second fishing hook having a barbed end; and
the secondary prey member is configured to receive, at least partially therethrough, the barbed end of the second fishing hook.

6. The fishing lure assembly of claim 1, wherein:
the primary prey member is configured as a crawfish having a first appendage; and
the secondary prey member is attached to the first appendage.

7. The fishing lure assembly of claim 6, wherein the secondary prey member is configured as a shad.

8. The fishing lure assembly of claim 6, wherein:
the first appendage has a holding claw disposed at a distal end thereof, the holding claw defining a holding chamber; and
at least a portion of the secondary prey member is received within the holding chamber.

9. The fishing lure assembly of claim 8, wherein:
the secondary prey member has a first end, a second end, and an intermediate portion disposed between the first end and the second end; and
the intermediate portion of the secondary prey member is received within the holding chamber such that the first end and the second end are disposed outside of the holding chamber.

10. The fishing lure assembly of claim 6, wherein:
the secondary prey member has a groove formed about an exterior thereof; and
the holding chamber is configured to engage the groove to attach the secondary prey member to the primary prey member.

11. A method for catching fish comprising:
providing a fishing lure assembly having a primary prey member and a secondary prey member, the primary prey member being configured as fish prey of a first type, the secondary prey member being configured as fish prey of a second type and attached to the primary prey member, the first type and the second type being different types of fish prey;
disposing a barbed end of a first fishing hook at least partially through the primary prey member;
attaching a fishing line to the first fishing hook; and
casting the fishing lure assembly into a body of water.

12. The method of claim 11, wherein casting the fishing lure assembly comprises releasing a length of the fishing line to enable the fishing lure assembly to rest on a bottom of the body of water.

13. The method of claim 11, further comprising disposing a barbed end of a second fishing hook at least partially through the secondary prey member.
